(19) United States
(12) Patent Application Publication
(10) Pub. No.: US 2016/0176152 A1
(43) Pub. Date: Jun. 23, 2016

(54) HOLLOW CORE COMPOSITE

(71) Applicant: Ray ARBESMAN, (US)

(72) Inventor: Winston MACKELVIE, Knowlton (CA)

(21) Appl. No.: 14/580,333

(22) Filed: Dec. 23, 2014

(51) Int. Cl. B32B 3/30; B32B 38/00; B32B 37/18; B32B 37/04; B32B 3/28; B32B 15/08

(52) U.S. Cl. CPC B32B 3/30; B32B 3/28; B32B 15/08; B32B 37/182; B32B 37/04; B32B 38/0012; B32B 2605/00

(57) ABSTRACT

Embodiments of the invention include a composite panel consisting of a thermoplastic core sandwiched between two skins of textured material, such as steel sheeting with barbs raised from one face. The core is made from hollow core elements, such as balls or tubes. The barbs penetrate the core elements on either side to lock the panel together. This is facilitated by heating the skins so that the barbs are hot enough to cause the core material to melt so that after it cools it solidifies around the barbs causing the skins and core to be locked together. The core may be a two-dimensional array of spherical elements or a series of tubes placed side by side for example.

### BACKGROUND OF THE INVENTION

1. Field of the Invention

Embodiments of the invention relate generally to composite materials, and more particularly to composite materials with hollow cores.

2. Description of the Related Art

Composites are much lighter, stiffer and stronger than the individual layers of material of which they are comprised. Currently they are widely used for making planes, race cars, yachts and the like, where efficiency and performance are paramount and cost a secondary consideration. High composite cost limits wider use.

High level composites use fabrics of glass or carbon along with thermoset adhesives. Vacuum bagging, custom mould tools, and pressurized autoclave ovens are needed. Such sophisticated materials, equipment, processes and the skilled labour required, together are what make current composites expensive.

In contrast, thermoplastics such as Nylon™, polyethylene and polypropylene, are relatively inexpensive but have limited use in composites because they have low surface energy making them difficult or impossible to bond with adhesives. And because of their poor heat conductivity, hot welding them is slow and difficult to validate. There is a need for inexpensive ways of using thermoplastics in composites.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

Composites of the type contemplated in the instant invention comprise thin skins of sheet material (such as plastic, metal or wood) that sandwich a much thicker core material (such as honeycomb board, hard foam, formed ribs, corrugate and the like). Generally, the further apart the skins, the stiffer the resulting composite panel.

Embodiments of the invention provide a composite panel having a core and two skins. The core includes at least one core element, and each core element has a hollow interior region. Each skin has one face textured with barbs. The core is sandwiched between the skins so that a multiple barbs on each skin penetrate into each core element.

The core elements are preferably made of a thermoplastic material. The composite panel may then be formed by heating and pressing each skin against the core elements to cause the barbs to penetrate the core elements so that when the heat is removed, the thermoplastic solidifies around the penetrating barbs to lock the skins and core together.

Each skin is preferably a sheet of metal with pointed barbs, with the two skins substantially parallel to each other.

The core preferably comprises multiple similarly shaped core elements.

One or more than one core element may be tube shaped, or all core elements may be tube shaped. One or more than one core element is may be spherical, or all core elements may be spherical. One or more than one core element may have a rectangular or trapezoidal cross-section.

The core may be a dimpled thermoplastic sheet, each dimple being a hollow core element.

The core may be a corrugated plastic sheet.

Each skin may be a sheet of metal with pointed barbs having pointed ends, such that one or more of the pointed barbs penetrate fully through a wall of each core element in the hollow interior region, and are clinched.

Each core element may be tube shaped, and the pointed ends of the barbs may then be clinched by drawing a plug through each core element.

The composite panel may include first and second cores, first and second outer skins, and one inner skin. Each core element has a hollow interior region. In such embodiments, the first and second outer skins have one face textured with barbs, and the inner skin has two faces textured with barbs. The first core is then sandwiched between the first outer skin and the inner skin so that one or more of barbs on each of the first outer skin and the inner skin penetrate into each core element in the first core, and the second core is sandwiched between the second outer skin and the inner skin so that one or more of barbs on each of the second outer skin and the inner skin penetrate into each core element in the second core.

The invention also provides a process for making a composite panel. The process employs a core with at least one core element having a hollow interior region, and first and second skins, each skin having one face textured with barbs. The textured face of the first skin is brought into contact with the core. The first skin and core are then pressed together to cause at least one of the barbs to penetrate each core element. The textured face of the second skin is also brought into contact with the core (before, after or at the same time that the first skin is brought into contact with the core) and the second skin and core are then pressed together to cause at least one of the barbs to penetrate each core element (before, after or at the same time that the first skin and core are pressed together).

In this process, the core elements are preferably made of a thermoplastic material, and the steps of bringing the textured face of the first skin into contact with the core and bringing the textured face of the second skin into contact with the core each may also include heating the skin so that the barbs are sufficiently hot to cause the thermoplastic material to at least partially melt where contacted by the barbs, so that when the barbs have penetrated the core elements and the heat is removed, the thermoplastic solidifies around the penetrating barbs to lock the skins and core together.

### BRIEF DESCRIPTION OF THE DRAWINGS

In the figures, a symbol containing the letter “F” surrounded by wavy lines is used to indicate that the adjacent surface is heated.

FIG. 1 is a perspective view of a piece of sheet material having four barbs with four different shapes—pointed, headed, hooked, and curved.

FIG. 2 is a cross-section edge view through a piece of textured sheet and through a single row of barbs.

FIG. 3 is a cross-section side view through a piece of textured sheet with a row of barbs on each face of the sheet with the lower face showing how a pressure plate may be used to form headed barbs by deforming the tips of pointed barbs.

FIG. 4 is an end view of the piece of textured sheet of FIG. 3.

FIG. 4a is a perspective view of a textured metal sheet showing parallel rows of spaced barbs.

FIG. 5 is an end view of a composite core tube resting on the barbs of a composite skin. A channel shaped pressure plate is shown urging the barbs and skin together.

FIG. 5a shows the composite core tube and composite skin of FIG. 5 where the core and pressure channel walls have come to rest on the support surface and the core's melt plane has engulfed the contacting barbs.

FIG. 5b shows the composite core tube and composite skin of FIG. 5 where the assembly has been inverted onto a second skin, the pressure shim removed and the core wall melt plane engulfing the barbs of the second skin.

FIG. 5c shows an auxiliary layer of material being sandwiched between a core and a skin so as to meld with the barbs into the core wall.

FIG. 5d is an enlarged view of a portion of the elements depicted in FIG. 5c after the melding of the core, auxiliary layer and barbs.

FIG. 5e illustrates a process where a support plate on the left is heated and a support plate on the right is cold. The assembly is slid onto the cold plate while maintaining pressure and is held there until the core wall re-solidifies.

FIG. 6 is an end view of a portion of a composite panel showing a side-by-side arrangement of sections of core tubes connected to heated skins by barbs that have melted into the tube walls.

FIG. 7 is a longitudinal cross-section of an embodiment showing skins with differently shaped barbs and pointed barbs that have been post-shaped by pulling a plug through the tube so as to bend or rivet over the tips of pointed barbs.

FIG. 8 is a perspective view where three skins and two tubular core sections have been made into a composite panel (the top skin is not shown for clarity) and where the core tubes of one layer are at right angles relative to the core tubes of the other layer. Also shown is how core tube ends may be sealed closed, filled with foam, and/or have an air fitting, and, where the tubes can be being used as conduits for fluid flows or for utility items such as wire or pipe.

FIG. 9 is a cross-section end view of non-round core tubes, some spaced apart.

FIG. 10 is a perspective view of a dimpled thermoplastic sheet that can serve as a core in embodiments of the invention.

FIG. 11 is an end view of an embodiment of the invention showing the dimpled thermoplastic sheet of FIG. 10 between textured skins and showing heat being applied from above and below to connect the skins to the dimpled core.

FIG. 12 is a perspective view of the same embodiment as shown in FIG. 11.

FIG. 13 is a perspective view of an embodiment of the invention with hollow thermoplastic spheres or balls used as core elements.

FIG. 14 is a perspective view of a short piece of core tube element where the ends have been sealed.

FIG. 15 is a schematic top view of multiple arrangements of core tube elements, all lying on a lower skin.

FIG. 15a is a schematic top view of strips and patches of auxiliary material that have been pre-applied to a barbed skin at locations where core elements are to make contact.

FIG. 16 is an end view of another embodiment of the composite with a corner formed by pre-bending the skins to receive tubular core pieces and depicting the first step where a formed pressure plate urges the core elements onto the barbs of the heated outer skin.

FIG. 17 depicts the next step after that shown in FIG. 16 where the pressure plate is heated to urge the inner skin onto the core elements, completing the corner composite.

FIG. 18 shows the same embodiment as a completed corner composite and including an end treatment whereby an adjacent panel may be inter-locked and the joint adhesively filled locking the engaged barbs together.

FIG. 19 shows another embodiment of the invention having tapered flanges created by tubular core members of differing diameters, including solid core elements at the end locations with threaded fasteners.

FIG. 20 shows tube and/or sphere core elements irregularly arranged and then moved under pressure laterally and vertically into their final position as the hot barbs melt their way in.

FIG. 21 shows the embodiment of FIG. 20 with the upper skin heated and force-melted into the cores, completing the composite panel fabrication.

FIG. 22 shows core tubes of different diameters being used to create a composite panel having a taper.

FIG. 23 shows a tapered composite panel where the outer core tubes are of oval shape.

FIG. 24 shows an embodiment of a composite panel made with a one-piece core of corrugated plastic commonly referred to as Coroplast™.

FIG. 25 shows a core of corrugate shape having flat peaks to engage a maximum number of barbs.

FIG. 26 shows the embodiment of FIG. 25 assembled into a composite panel.

FIG. 27 shows an end view of a tube core panel with auxiliary strips sandwiched between core elements and outer skins.

FIG. 28 is a schematic view of a continuous production process using coils of textured sheet metal for the skins and a set of coils of tubing, where all three components are layered and enter a heating station on a sandwich-style metal belt conveyor that also applies compressive force, followed by a cooling section also under pressure, and a cut-off station where individual panels are severed.

FIG. 29 is a schematic of hollow spheres and textured skins continuously assembled into composite panel using the heat-pressure-cool-pressure technique depicted in FIG. 28.

FIG. 30 is a schematic end view of the tubing process of FIG. 28 but showing only the side-by-side arrangement of coils of tubing to match the width of the textured sheet skins (only one shown).

FIG. 31 shows sample shapes of hollow core elements that can be used on edge to separate and join skins (not shown).

FIG. 32 shows a hollow core composite using the tube stubs between textured sheet skins.

### DETAILED DESCRIPTION

The composite material generally is formed from at least two “skins” and at least one “core” sandwiched between the skins. The skins of the composite are textured sheet material characterized by a “forest” of small, raised barbs on one or both faces of the sheet. The forest of barbs may resemble Velcro™ hooks. Preferably the skin is sheet metal, such as steel.

The core of the composite is made of hollow, rigid thermoplastic elements such as tubes, spheres, dimples, corrugate, foam and the like. Of course solid elements may also be used, such as rods, balls, mesh and the like, where the weight of the composite is less of a concern. Solid core elements may be mixed with hollow core elements. As well, solid core elements can be drilled and threaded to accommodate fasteners between the panel and adjacent structures.

To make the composite, the skins and core are assembled as a sandwich and the skins heated from the outside while the core elements remain cool and rigid. The barbs on the skins melt their way into the walls of the core elements. When cooled, the barbs are locked into the core and a novel low-cost, lightweight and stiff composite panel results.

Advantageous properties of the composite include floatability, thermal and sound insulation, built-in conduit, fireproof, paintability, magnetic attraction, surface welding, and threaded fastener attachment.

Textured sheet materials suitable for use as skin layers in the instant invention, are available from Nucap Industries (Toronto Canada). Such materials are described in Canadian Patent No. 2,760,923, issued on Mar. 11, 2014, Canadian Patent Application No. 2,778,455, published on Jun. 6, 2013, Canadian Industrial Design Registration No. 145893, registered on Dec. 10, 2013, U.S. Pat. No. 6,843,095, issued on Jan. 18, 2005, U.S. Pat. No. 6,910,255, issued on Jun. 28, 2005, each of which is hereby incorporated into this document by reference.

The composite material or panel comprises rigid, hollow thermoplastic core elements assembled and sandwiched between skins of textured metal having raised barbs. Only the skins need be heated. Pressure is applied to the skins causing their barbs to melt their way into the thermoplastic core material. The pathway melted by the barbs displaces a like volume of liquid thermoplastic which flows back along and under the hooked or headed barb thereby embedding the barb. On cooling, the embedded barbs lock the skins and core together resulting in a light, rigid, low-cost, easy to manufacture composite panel.

In the instant invention, textured sheet metal is preferred for the skins because the barbs remain stiff at the temperatures and pressures needed to form the panels. Steel, aluminum and other metals and materials can be textured with a variety of barb profiles (headed, pointed, hooked, curved), in a range of densities, for example, 200-1300 per square cm (or 30-200 per square inch) and heights, for example, 0.03 to 0.15 cm (or 0.01 to 0.06 inches), and with partial or total coverage of one or both faces of the sheet.

Hollow thermoplastic core elements may include, but are not limited to, tubes, spheres, dimpled sheet, corrugate, and foam. Being hollow they are normally, by volume, mostly air and are therefore relatively light, which results in a lightweight composite panel.

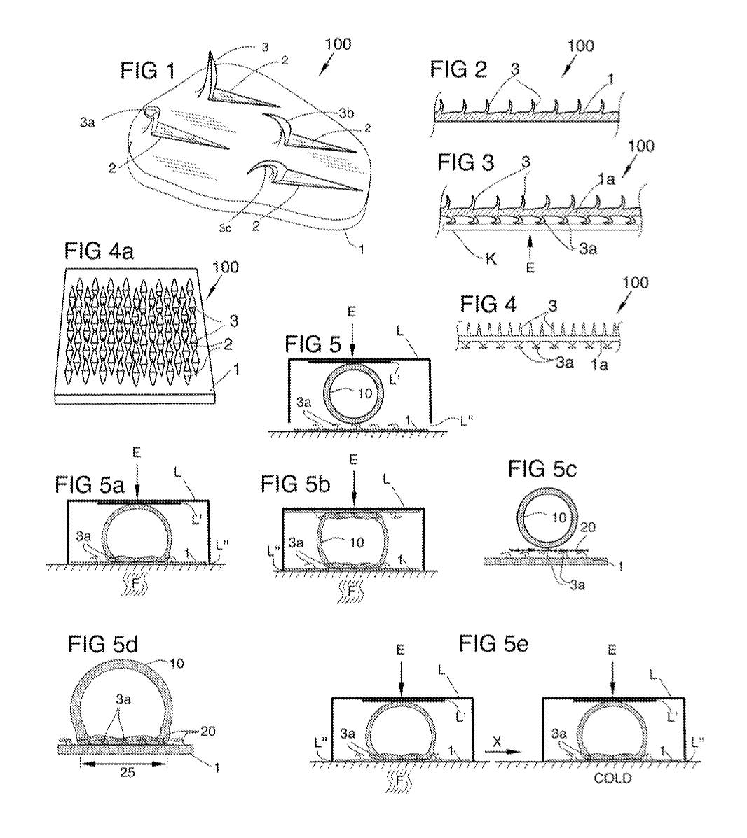

For illustrative purposes, FIGS. 1 to 4a shows small portions of textured sheet 100 comprising sheet 1, 1a and different barbs 3, 3a, 3b, 3c rising from the surface. Sheet 1 has barbs on one face only while sheet la has barbs on both faces.

FIG. 1 shows the profiles of four barbs, namely: pointed barb 3, headed barb 3a, hooked barb 3b, and curved barb 3c. Each profile provides various properties and uses that depend on the adjoining material and the method of fabrication used. The barbs may be carved or ploughed (plowed) up from a groove 2 by the tip of toothed blades (not shown). Different barbs can formed on either face and in different places on either face if desired. For example alternating rows of hooked and headed barbs could be formed on a face of a sheet.

FIG. 2 is a side view through a sheet 1 with a single row of pointed barbs 3, FIG. 3 is a side view of sheet 1a having rows on both faces and where the pointed barbs 3 on the lower sheet face have been partially crushed by a plate K under force E to produce headed barbs 3a.

FIG. 4 is an end view of sheet 1 with rows of pointed barbs 3 and headed barbs 3a in parallel rows formed using toothed blades that are linear and arranged side-by-side (not shown). FIG. 4a is a perspective view showing rows of barbs in tandem.

FIGS. 5 through 5e show end views of a single composite core tube 10. The composite core tube 10 is shown first resting on the barbs 3a of a skin 1 in FIG. 5. A pressure plate L in the shape of a channel has side flanges of a length selected to limit downwards travel. A shim L′ takes up space equal to the thickness of two skins (excluding barbs). FIG. 5a shows that, with heat F, and pressure E, pressure plate L forces core tube 10 onto the skin 1 and creates a melt plane (see also FIG. 25) which increases until gap L″ closes, thereby preventing further descent. The pressure plate L also ensures that the top of the core remains parallel to the skin.

In FIG. 5b the non-assembled core and one skin is inverted onto the second skin resting on the heated support plate. The shim L′ is removed and the heat F and pressure E again cause the core wall to melt over the barbs 3a, while the two skins remain parallel.

In FIG. 5c an auxiliary layer 20 of thermoplastic sheet, film, fabric, or inorganic fibre-fabric, such as fiberglass, steel wool, and the like, is shown between the skin 1 and core 10. As the hot barbs penetrate by melting through the film or pushing through the fibre, auxiliary layer 20 becomes entrained into the barbs' anchoring regions to add strength. FIG. 5d is an enlarged view of the same embodiment.

FIG. 5a shows the same embodiment where the core and pressure channel above come to rest and the core's melt plane has engulfed the contacting barbs.

FIG. 5e shows right and left views of the same embodiment where on the left the core melt has taken place and, as shown with arrow X, the assembly is slid onto the cold support plate (still under pressure E) on the right so as to cool the thermoplastic and complete the composite panel fabrication.

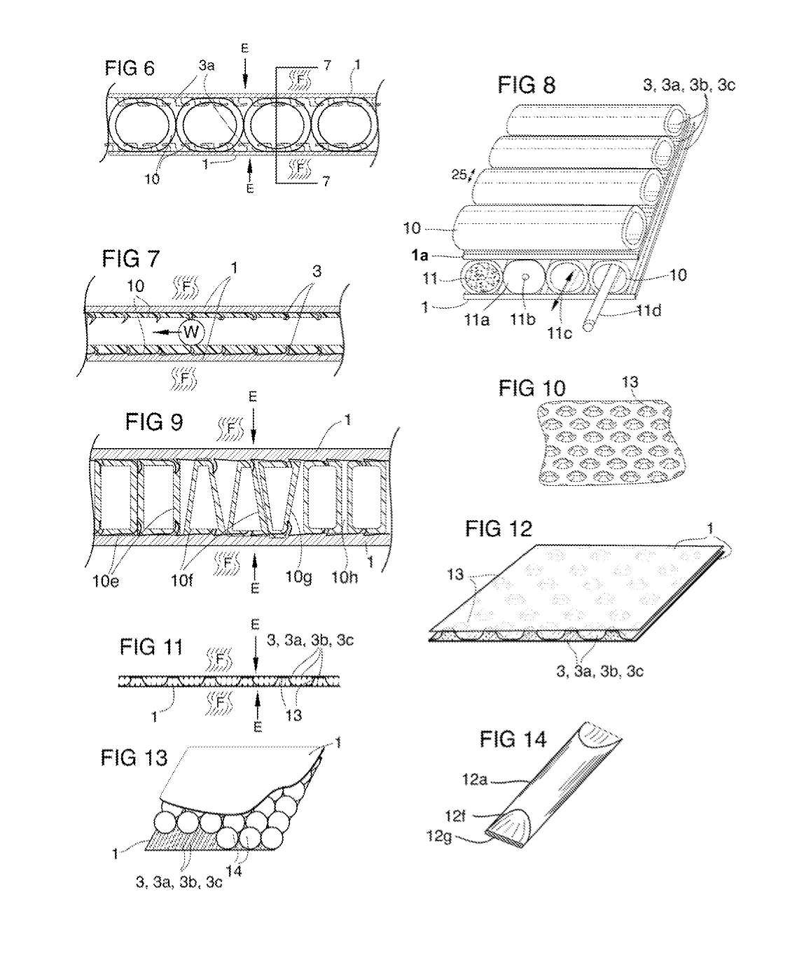

FIG. 6 shows an end view of tubes 10 arranged side-by-side and having been melted into simultaneously by headed barbs 3a of upper and lower skins 1 using heat F and force E, thereby creating an air core composite panel. FIG. 7 is a cross section view through one tube in FIG. 6 showing pointed barbs 3 being used to melt into tube core 10. The pointed barbs 3 on the top skin 1 have been chosen to fully penetrate the upper tube wall such that their tips are exposed along the tube's interior. In a post-assembly operation, a plug W is depicted being drawn through the tube (to the left in FIG. 7) to clinch or rivet over the tips (converting pointed barbs into headed barbs) to add anchor strength.

FIG. 8 shows how a two layer air core composite panel can be fabricated using outer skins 1, tubular cores 10, and a middle third skin 1a, which has barbs on both faces, separating the two core layers which are arranged crosswise to equalize panel stiffness in all directions. The upper skin has been removed (i.e. is not shown in FIG. 8) for clarity but the melt planes 25 created are between the depicted dotted lines on the tubular cores 10. In the assembly of such a multi-layer composite panel, the middle skin 1a and cores 10 can be assembled using induction or microwave energy (or some other non-contact heating means) whereby the cores remain cool and skin 1a alone is heated. Then the outer skins can be added using contact heat like contact heat F shown in FIGS. 6 and 7.

Also shown in FIG. 8 is how the use of hollow core elements, such as sections of tube, can offer other benefits. For example, such tubes can be filled with foam 11, or have the ends plugged 11a and the plug may have a fitting 11b to, for example, pressurize the tube to add stiffness to the core. The tubes can be used for fluid passage 11c or to act as conduit for wires 11d, pipes, cables and the like.

FIG. 9 shows non-round tube cores, including rectangular tubes 10e and trapezoidal tubes 10f, in regular alignment and nested 10g. A space 10h can optionally be left between hollow cores to lower core count and therefore panel weight.

FIG. 10 shows a portion of thin dimpled sheet material 13, like some materials designed for use under floors and which is available in large rolls. Placed between heated skins 1, as shown in FIGS. 11 and 12, and with light force E, another embodiment of composite panel is created.

FIG. 13 is a different embodiment of the instant invention using a core comprising multiple hollow spheres 14 as core elements.

FIG. 14 shows how the ends 12f of tubular core element 12a may be optionally sealed 12g. Such sealing can, for example, prevent ingress of unwanted materials and provide buoyancy.

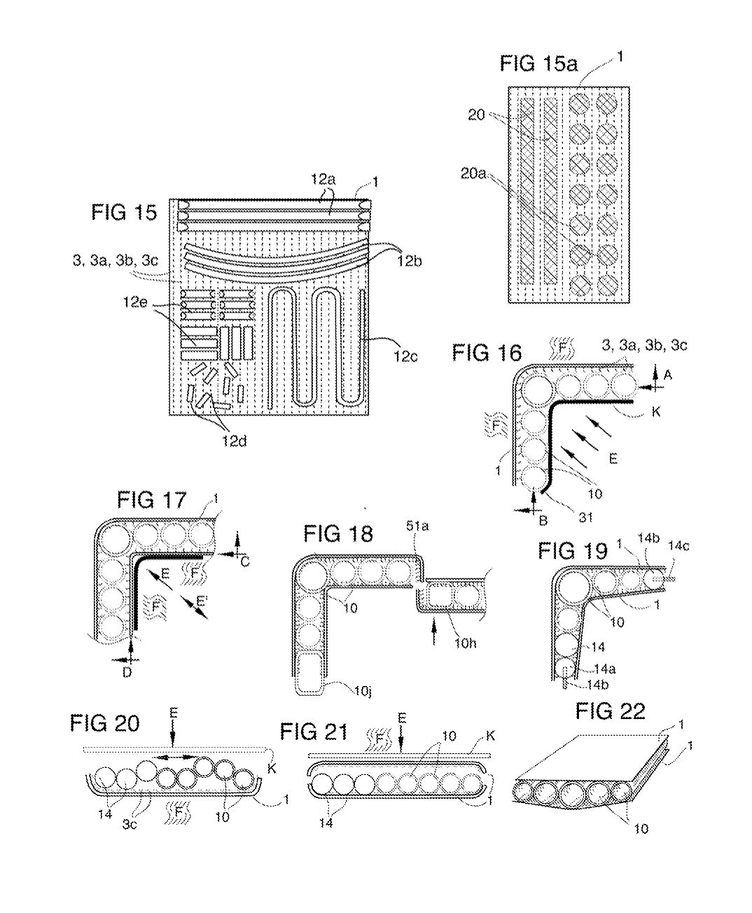

FIG. 15 shows schematically how a variety of hollow core elements may be arranged on skin 1. Long sealed end tubes 12a and curved tubes 12b can be arranged side-by-side, as a serpentine 12c, using random pieces 12d, and in patterns using short lengths 12e.

FIG. 15a shows how an auxiliary material such as thermoplastic sheeting, fabric or film, or glass carbon fibre, mesh, film, sheet and the like may be used to augment anchoring of the barbs and core. For example, strips 20 shown in FIG. 15a are suitable for tube shape core elements and patches 20a for spherical elements.

FIGS. 16-19 illustrate how corners and other shaped panels can be fabricated. FIG. 16 shows a pre-bent outer skin 1 with adjacent hollow core elements 10, and on cold plate K positioned beside the core elements 10. Using heat F to heat the outer skin 1 and pressure Eon cold plate K, core elements 10 move in and laterally (arrows A, B). The core elements move in two directions to reach the skin. As a result, the hot barbs melt a skewed path into the core walls as force E on cold plate K moves the core elements into place.

In FIG. 17, using heat F and pressure E, hot pressure plate K pushes an inner skin, having barbs on its inner face, against the surfaces of the core elements 10, resulting in a skewed melting path (arrows C, D) of the heated inner skin's barbs through the now stationary cores' walls.

For such skewed motion some oscillation E′ of the pressure plate K may be advantageous to help urge the barbs through the molten thermoplastic, as depicted in FIG. 17. As well, pressure plate E may benefit from having a flange 31, as shown in FIG. 16, to ensure that the cores stay tight together.

Such skewed barb travel is also illustrated in FIGS. 20 and 21 where the collated cores are too wide (FIG. 20) to fit between the curved end walls of the skin 1 until the hot barbs melt into them such that they slide laterally and vertically into position (FIG. 21).

FIG. 18 illustrates a treatment for the ends of the composite panel (right end) where an overhanging portion of one skin on adjacent panels is bent into a flange with a gap 51a sufficient for the like flange of the adjacent panel to enter (arrow). The intertwined barbs in the gap 51a along with adhesive (not shown), can provide a sealed and secure joint. Another approach to joining composite panels is to use an elongated core element 10j (bottom left end of FIG. 18) to provide an attachment means to adjacent structures including a panel made according to the instant invention. Such an elongate core element may also be solid (meaning not hollow).

FIG. 19 shows how different diameter core tubes 10 and/or spheres 14 can be used to effect a taper to a right angle composite panel. Similarly, FIG. 22 depicts effecting a taper using a flat composite panels. Such a shape provides additional strength at the centre while adding minimal weight. Also shown in FIG. 19 is how solid core elements 14b can be used, for example, at the panel ends to receive threaded fasteners 14c (such as studs, nuts, inserts, through holes, locks, latches, weldments, and the like) for connection to adjacent structures including adjacent composite panels.

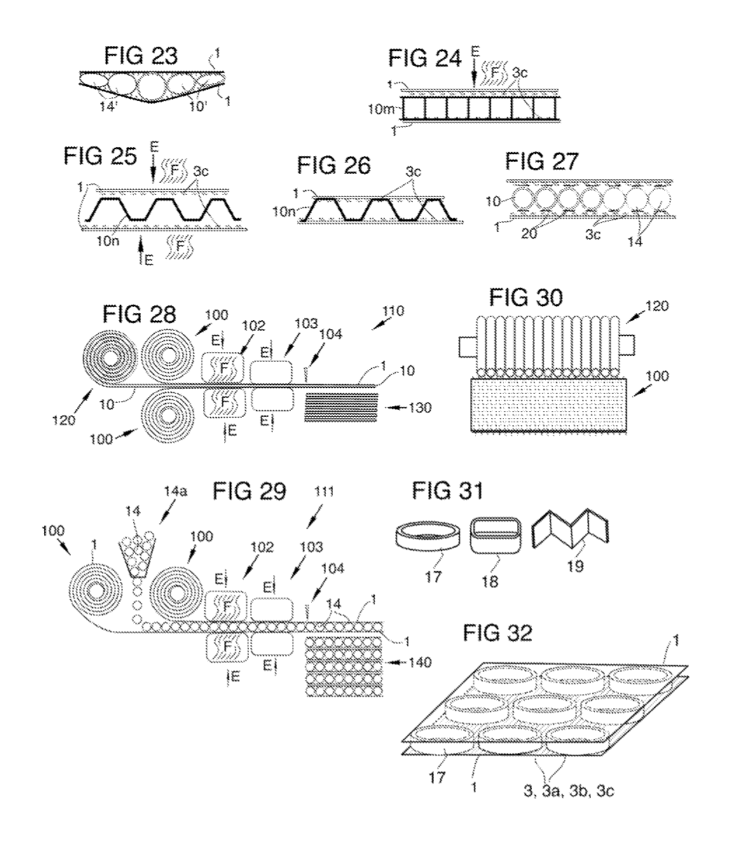

FIG. 23 shows another embodiment of a tapered panel where ovalized tubes 10′ or spheres 14′ serve as hollow cores.

FIG. 24 shows another embodiment that utilizes corrugated plastic (copolymer resin) sheet 10m as the hollow core. Commonly know by the trade name Coroplast™, it comprises flat outer skins formed in one piece with vertical channel walls between. Being thermoplastic, skins 1 can be added by the methods previously described herein.

FIGS. 25 and 26 show a hollow core of corrugate 10n between textured sheet skins joined with heat F and pressure E.

FIG. 27 shows how minimal amounts of auxiliary material 20 can be pre-assembled with the skins and/or to the cores so as to meld into and strengthen the anchor zone.

FIGS. 28 to 30 show schematically how the composite panel invention can be made in a continuous process from coils of skin and sheet material. In FIG. 28 the hollow core 10 is tubing, foam, dimple sheet, corrugate or the like, fed from coil 120. Textured skin material is fed from coils 100. The three feed into the tapered opening of a steel belt press such that at station 102 heat F and pressure E are applied to top and bottom skins, securing them to the core as previously described. At station 103 there is no heat F but pressure E is maintained, resulting in the skins cooling while the barbs remain fully embedded in core wall. Station 104 cuts finished panels to the length required (item 130).

The same process is shown in FIG. 29 where the hollow core is made from multiple hollow spheres 14 dropped from a hopper 14a onto lower skin 1 fed from coil 100, where the upper skin traps the spheres 14. As in FIG. 28, heating station 102 applies pressure E, and the composite panel passes through cooling station 103 where pressure E is maintained. Also as in FIG. 28, cutting station 104 severs the continuously produced composite panel to desired length panels 140.

FIG. 30 shows a view from the left side of FIG. 28, so that without stations 102, 103 and 104, and with upper coil 100 are not visible. The coils of tubing 120 are arranged side-by-side to provide a core of a width sufficient for the width of skin in coil 100.

FIG. 31 shows some example shapes of stiff, thermoplastic core elements that can be used in an “edge-way” alignment. Placed on edge between the skins, the skins are then heated (separately or simultaneously) and pressure applied to cause the barbs from the skins to melt their way into the edge or rim or end surfaces of the core elements. FIG. 32 shows a phantom view of such a hollow core composite comprising upper and lower skins 1 sandwiching an array of short lengths of tube cores 17 on edge. As per the preceding description, the barbs have become locked into the tubes' walls, thereby creating a light, stiff, economical campsite panel.

The abbreviation “cm” as used herein refers to centimetres (or in the US, “centimeters”).

The adjective “parallel” as used herein with respect to skins or surfaces is not intended to imply that the surfaces are flat, but rather that they are similarly shaped. Such surfaces are also referred to as “offset surfaces”.

It should be understood that the above-described embodiments of the invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description and figures as a whole.

We claim:

1. A composite panel comprising (a) a core comprising at least one core element, each core element having a hollow interior region, and (b) two skins, each skin having one face textured with barbs, wherein the core is sandwiched between the skins so that a plurality of barbs on each skin penetrate into each core element of the core.

2. The composite panel of claim 1, wherein the core elements are made of a thermoplastic material, and the composite panel is formed by heating and pressing each skin against the core elements to cause the barbs to penetrate the core elements so that when the heat is removed, the thermoplastic solidifies around the penetrating barbs to lock the skins and core together.

3. The composite panel of claim 1, wherein each skin is a sheet of metal with pointed barbs, and the two skins are substantially parallel to each other.

4. The composite panel of claim 1, wherein the core comprises a plurality of similarly shaped core elements.

5. The composite panel of claim 1, wherein at least one core element is tube shaped.

6. The composite panel of claim 5, wherein a plurality of core elements are tube shaped.

7. The composite panel of claim 1, wherein at least one core element is spherical.

8. The composite panel of claim 7, wherein a plurality of core elements are spherical.

9. The composite panel of claim 1, wherein a plurality of core elements have a rectangular or trapezoidal cross-section.

10. The composite panel of claim 1, wherein the core is a dimpled thermoplastic sheet, each dimple being a hollow core element.

11. The composite panel of claim 1, wherein the core is a corrugated plastic sheet.

12. The composite panel of claim 1, wherein each skin is a sheet of metal with pointed barbs having pointed ends, wherein one or more of the pointed barbs penetrate fully through a wall of each core element in the hollow interior region, and are clinched.

13. The composite panel of claim 12, wherein each core element is tube shaped, and the pointed ends of the barbs are clinched by drawing a plug through each core element.

14. The composite panel of claim 1 comprising (a) first and second cores, each core comprising one or more core elements, each core element having a hollow interior region, (b) first and second outer skins, each outer skin having one face textured with barbs, and (c) one inner skin having two faces textured with barbs, wherein the first core is sandwiched between the first outer skin and the inner skin so that one or more of barbs on each of the first outer skin and the inner skin penetrate into each core element in the first core, and the second core is sandwiched between the second outer skin and the inner skin so that one or more of barbs on each of the second outer skin and the inner skin penetrate into each core element in the second core.

15. A process for making a composite panel, the process comprising:
providing a core comprising at least one core element having a hollow interior region;
providing first and second skins, each skin having one face textured with barbs;
bringing the textured face of the first skin into contact with the core;
pressing the first skin and core together to cause at least one of the barbs to penetrate each core element;
bringing the textured face of the second skin into contact with the core; and
pressing the second skin and core together to cause at least one of the barbs to penetrate each core element.

16. The process of claim 15, wherein the core elements are made of a thermoplastic material, and the steps of bringing the textured face of the first skin into contact with the core and bringing the textured face of the second skin into contact with the core each further comprise heating the skin so that the barbs are sufficiently hot to cause the thermoplastic material to at least partially melt where contacted by the barbs, so that when the barbs have penetrated the core elements and the heat is removed, the thermoplastic solidifies around the penetrating barbs to lock the skins and core together.
